(19) United States
(12) Patent Application Publication
(10) Pub. No.: US 2017/0109699 A1
(43) Pub. Date: Apr. 20, 2017

(54) INCENTIVE-BASED EXCHANGE FOR PROJECT CONTRIBUTION

(71) Applicant: Craig P. Mowry, Southampton, NY (US)

(72) Inventor: Craig P. Mowry, Southampton, NY (US)

(21) Appl. No.: 12/938,118

(22) Filed: Nov. 2, 2010

Related U.S. Application Data
(63) Continuation-in-part of application No. 12/858,132, filed on Aug. 17, 2010, now abandoned.
Application No. 12/858,132 is a continuation-in-part of application No. 12/454,948, filed on May 26, 2009, now abandoned.
Application No. 12/454,948 is a continuation-in-part of application No. 11/517,114, filed on Sep. 6, 2006, now abandoned.
(60) Provisional application No. 61/234,582, filed on Aug. 17, 2009.
(60) Provisional application No. 60/714,275, filed on Sep. 6, 2005.
(60) Provisional application No. 60/739,354, filed on Nov. 22, 2005.
(60) Provisional application No. 61/257,309, filed on Nov. 2, 2009.

(51) Int. Cl. G06Q 30/00; G06Q 10/00

(52) U.S. Cl. CPC G06Q 10/103

(57) ABSTRACT

A system and method is disclosed for exchanging an incentive for a project contribution. At least one electronic database includes project information, electronic media associated one or more projects, incentive information representing at least one incentive, and user information representing a plurality of registered users. At least one first electronic media related to at least one first project is received, and at least some of the incentive information is selected that is respectively related the project(s). At least one electronic prompt related to the at least some of the electronic incentive information is generated, and transmitted to a device. A response to the prompt is received, and media distribution information is generated that is based on the first media. Further, a request for at least feedback associated with the electronic media distribution information is generated and transmitted, and feedback is received. Thereafter one or more incentives are provided.

### CROSS-REFERENCE TO RELATED APPLICATIONS

The present patent application is a continuation-in-part of U.S. patent application Ser. No. 12/858,132, filed Aug. 17, 2010 and entitled SYSTEM AND METHOD FOR PROVIDING INCENTIVES IN EXCHANGE FOR RECEIVING PROJECT CONTRIBUTIONS, which is based on and claims priority to U.S. Provisional Patent Application Ser. No. 61/234,582, filed Aug. 17, 2009, and entitled SYSTEM AND METHOD FOR PROVIDING INCENTIVES IN EXCHANGE FOR RECEIVING PROJECT CONTRIBUTIONS (II), and further the present patent application is a continuation-in-part of U.S. patent application Ser. No. 12/454,948, filed on May 26, 2009 and entitled ENTERTAINMENT DISTRIBUTION SYSTEM AND METHOD, which is a continuation-in-part of U.S. patent application Ser. No. 11/517,114, filed on Sep. 6, 2006 and entitled “SYSTEM AND METHOD FOR PROVIDING INCENTIVES IN EXCHANGE FOR RECEIVING PROJECT CONTRIBUTIONS (as amended),” which is based on and claims priority to U.S. Provisional Patent Application Ser. No. 60/714,275, filed on Sep. 6, 2005 and entitled “SYSTEM AND METHOD FOR ELICITING VIEWER FEEDBACK REGARDING ENTERTAINMENT PROJECTS' VIABILITY AND ACQUIRING FRONT END FUNDING FROM SAID VIEWERS FOR THOSE PROJECTS DETERMINED TO HAVE REVENUE POTENTIAL,” and to U.S. Provisional Patent Application Ser. No. 60/739,354, filed on Nov. 23, 2005 and entitled “SYSTEM AND METHOD FOR ELICITING VIEWER FEEDBACK REGARDING ENTERTAINMENT PROJECTS' VIABILITY AND ACQUIRING FRONT END FUNDING FROM SAID VIEWERS FOR THOSE PROJECTS DETERMINED TO HAVE REVENUE POTENTIAL (ADDITIONAL DISCLOSURE),” and further, the present patent application is based on and claims priority to U.S. Provisional Patent Application Ser. No. 61/257,309, filed Nov. 2, 2009 and entitled INCENTIVE-BASED EXCHANGE FOR PROJECT CONTRIBUTION, the content each of all the above-identified patent applications is incorporated in its entirety by reference as if set forth herein.

### FIELD OF THE INVENTION

The present invention relates, generally, to a computer implemented system and method for funding entertainment projects and, more particularly, to promoting and distributing media devices electronically over a communication network that include and/or provide access to incentives for project participants.

### BACKGROUND

Typically, entertainment projects, such as distributed on television and in movie theaters, require a significant and often impractical initial financial production investment. As used herein, such initial investment is referred to as a “front end” investment, because payments have to be made initially “up-front” before an entertainment project goes into production. For a full-length feature film and depending on the individual production, front-end investments can be in the tens of millions of dollars. For example, it is becoming common that front-end investments relating to the production of a film featuring many special effects, such as CGI, may exceed one hundred million dollars or more to produce.

Unfortunately, returns on front-end investments are often not realized once an entertainment production goes into distribution, for example, on television or in movie theaters. Some films funded by studios alone or in conjunction with third parties, and many independent films never reach distribution of any kind, thereby resulting in complete financial loss. The return on front end investments is referred to herein, generally, as “back end investments,” and include ticket sales, numbers of viewers and corresponding advertising revenue, or the like. If the number of viewers is low, then, typically, returns on investments are not realized. Alternatively, a threat of low or no returns on front-end investments often results in entertainment productions never being made. Since the threat of low back end investments results in many projects that do not get made, another result is that homogenous groups of films are created by the major film studios for cinema and even television.

### SUMMARY

Accordingly, it is an object to provide a system and method for incentive-based exchange for project contribution.

A system and method is disclosed for exchanging an incentive for a project contribution. At least one electronic database includes project information, electronic media associated one or more projects, incentive information representing at least one incentive, and user information representing a plurality of registered users. At least one first electronic media related to at least one first project is received, and at least some of the incentive information is selected that is respectively related the project(s). At least one electronic prompt related to the at least some of the electronic incentive information is generated, and transmitted to a device. A response to the prompt is received, and media distribution information is generated that is based on the first media. Further, a request for at least feedback associated with the electronic media distribution information is generated and transmitted, and feedback is received. Thereafter one or more incentives are provided.

Other features and advantages of the present invention will become apparent from the following description of the invention that refers to the accompanying drawings.

### BRIEF DESCRIPTION OF THE DRAWINGS

FIG. 1 shows an example hardware arrangement for viewing, reviewing and outputting content over a communication network in accordance with an embodiment;

FIG. 2 is a block diagram that illustrates functional elements of information processor and/or a user workstation in accordance with an embodiment;

FIG. 3 illustrates three example storage devices formatted in various ways in accordance with example embodiments; and

FIG. 4 illustrates functionality provided and/or improved by the present system and method.

### DETAILED DESCRIPTION OF THE PREFERRED EMBODIMENTS

Systems and methods are provided for receiving funding or other value for creative projects by participants in unique and interactive ways. For example, Internet users operating web browser software applications from remote locations, such as homes, offices or public areas, are provided unique incentives to make financial contributions for one or more selected creative projects. Such incentives may include, for example, customized and/or alterable media that provide content, which may be specific to one or more participating users. The customized content may include on at least some information transmitted by participating users and received via a hub, for example.

In addition to custom content, cross-marketing features are supported and that may include customized media distribution devices that provide incentives in exchange for funds and/or other value from participants, relative to selected creative projects. The incentives may be content provided recorded on the devices and/or may be accessible by the devices. Alternatively or in addition, the customized media distribution devices, themselves, provide and/or promote content and/or give incentives for users to become members in a venue, or otherwise participate in a program that receives funding or other value in connection with a creative project.

In one or more embodiments, operability is provided in connection with one or more networked, internet or web-based, interactive sites as a basis for participants or users to interact. Internet users opting to contribute funds or other value to a project exemplifies one embodiment, however, other forms of interactive operability are envisioned herein, including interactive forums provided as a function of interactive cable television systems, interactive satellite systems, wired and wireless telephone networks, personal digital assistant (“PDA”) networks, or the like. In an embodiment comprising a computer communicating over the internet and operating as a host or server, users operating remote devices and connect to the computer, such as over the internet, and interface with one or more sites provided by the computer and/or with other users operating remote devices.

Many kinds of creative projects are supported by the teachings herein, such as entertainment projects, which may include movies, plays or other kinds of creative entertainment or artistic projects, as well as sports projects, or news, documentary and journalism-related projects. Thus, a broad range of projects is applicable, or at least affected, by the teachings herein. Projects may previewed and/or represented, such as via customized media, wherein the projects, per se, are not limited to being all or even in part of the media devices, themselves. In an embodiment, media represents a vehicle or kind of mode that at least presents a key aspect for conveying to users aspects of a project or creative opportunities in a new and interactive way.

In embodiments, types of creative projects may range from films, musical events, and may also represent a creative potential, be it of a hypothetical project or an actual person. Thus, the project may represent an opportunity that involves taking an interest in particular work or other determined value of a thing or individual, and which may be based on an aspect of performance or to increase in a valued aspect of a project or performer. Moreover, the customized media device may be presented to provoke an interest in a user, such as to provide interactive data, or to inform or support an offering, which, accordingly, may not be or involve a particular creative project itself. A creative individual, who might create, affect or participate in a plurality of projects, for example, may represent the object to/in which a user is prompted to contribute or otherwise participate in or otherwise be informed of and/or otherwise support as a function of interactive exchanges of information. Examples of such interactive exchanges may include opinions or funds.

For example, a not-for-profit project is designed to benefit a rural village in Africa. It is recognized that the project would benefit from a user's support. In order to obtain or gain access to the support, the user is prompted to receive special information, access and/or interactive privileges relative to the rural village. Alternatively or in addition, the user may be offered access to the not-for-profit project generally or specifically to the rural village. Further a user may be offered special credit, either in the form of a custom media device, to be provided exclusively to the user's computing device and/or to other users or external media viewers as a form of reward for the user's participation in the not-for-profit project. Moreover, a degree of reward, such as accrued points, personal credit or some other agreed-upon benefit may be offered or otherwise impacted to the user via selectively measured goals and/or success thresholds relative to the project. For example, one measured goal or threshold may a number of water wells that were installed successfully in the rural village by the not-for-profit project that is supported by the interactive user.

In an alternative embodiment, user participation may be provided as a function of cross marketing and established financial and service-based mechanisms. For example, credit card companies, banks, PAY-PAL or other payment services that provide automatic, semi-automatic or manual billing processes may be used to provide payment mechanisms for receiving funding. Other examples include cable or other television account “pay per view” format charges, internet service provider billing using corresponding payment information (e.g., credit card) or existing web site venue operating mechanisms are accessible to provide cross marketing or payment and collection systems associated with one or more vendors/businesses. For example, Amazon.com is an affiliated partner of a venue based on the teachings herein. Amazon.com provides electronic payment options and information for its users, and provides at least financial processing aspects of a venue, as well as one or more cross marketing opportunities

In an embodiment, the teachings herein preferably provide creative project “teasers” or samples of opportunities, not necessarily being limited to “creative” projects or large media products. The innovation may inform and/or fund projects from reality to selected people or groups of people, not-for-profits and other group-based or business-related endeavors. Thus, opportunities, referred to herein, generally, as “projects,” are presented in one or more media form, and may include incentives that at least partly involve subsequent or additional media being provided to the user after an initial or related network-based interaction occurs between the user and a site and/or other user. Accordingly, an option may exist for incentives, such as custom media devices, that represent or reflect aspects or characteristics of a project and the user himself/herself, in version(s) that are customized and potentially substantially automatically created for the user.

For example, a virtual talent agency is provided by the systems and methods herein. In such configuration, a user previews media relating to project opportunities, which may include actual people, such as actors who are associated with the virtual talent agency. A physical talent or other agency may be associated with or otherwise correspond to the virtual talent agency. After previewing the media relating to the project opportunities, such as shown and/or described by an actor, the user submits information, such as opinions in response to prompted options, or may provide unprompted feedback, as well as financial contributions to support the project opportunity. Such support may include, but not be limited to an investment or participation in the actor/project opportunity, the actor's continuing or ongoing performances or specific aspects of their association with specific project(s,) such as TV SHOWS, FILMS or other revenue generating work related to the actor's respective and particular abilities/talents.

Further, a user interacting with the site or other users may opt to support or otherwise participate in the project or opportunity by supporting or otherwise investing in the “future potential” of an actor, other individual, venture or thing. For example, a participant who opts for a percentage interest in the actor, Matt Damon, or, alternatively, a potential and yet unknown creative talent, might be provided with terms providing benefit, access, interactivity, funds or other redeemable rewards related to the actor or other talent. For example, opting into Matt Damon provides access to chat rooms with exclusive access, including members who have become “partners” of Matt through the venue. Some high level “partners” may be provided with live video dialogue with Matt, that lower level members may only be able to view, or provide feedback to by text. In other words, various tiers of interactive involvement may be structured to give incentive(s) for joining increasing and relative levels of involvement. A particular user who becomes a “partner” of the MATT DAMON offering, may be selected to attend the ACADEMY AWARDS ceremony with MATT DAMON. Further, personalized electronic media providing computerized operability may be offered to the user and that includes content provides MATT DAMON visibly and/or audibly saying or showing the participating user's name, or otherwise feature the user's name in some way.

Accordingly, projects may include things or individuals that are not based exclusively or primarily on creative material. Projects may include individuals who perform non-fictional work or functions, or those that may result in the creation of revenue or other “things,” albeit not otherwise considered creative, in the way, for example, that artistic projects are generally considered to be, such as films, television, theater, books, artwork or the like.

In accordance with an embodiment, user(s) provide feedback, opinions, information and/or financial funding, including as a function of subsequently provided media related to a project. In certain configurations, a customized media device is provided with one or more customized features and/or content that is specific to the user. Further, interactive data entry options, which may be specific to particular users who meet selected criteria, may be accessed or provided, as an additional incentive for participation in project(s). For example, a creative venue based in an exemplary configuration around funding or sponsoring innovators, such as inventors and/or inventions created by such innovators, provides incentives relative to participation by user(s). Such incentives may include access to the innovator and/or information related to the innovator, for example, provided as live, recorded or interactive video. Film credits or other kinds of rewards may also be accrued relative to the performance or a preset gauge that is relative to the innovator(s) and/or work products. Such credits may provide access to interactive opportunities, and/or opportunities with cross marketing partners, including internet sites, businesses affiliates and/or partners.

For example, data are provided to a user, such as in interactive, on-line transmissions, and when accessed one or more media incentives are provided that are specific to users who meet thresholds or criteria of participation. As noted above, these may include chat session access, messaging access to the innovator(s) or others in a form of a user group that supports interactions relative to innovator(s) or the like. In this way, a cooperative venue for innovation, wherein users may inform, fund or other wise express interest in innovations and/or innovator(s) is exemplary and demonstrative of the range of “people” and “creation” based themes and configurations that are possible.

Further, the potential of users feedback, opinions, information and/or financial funding, for projects that are completed, still in progress, not yet begun provides opportunity where none may have previously existed. For example and in connection with feature films, options for projects not yet produced, projects with or without finished screenplays, projects that are photographed but not yet edited or beyond “rough cut” edit versions, as well as projects completed though not yet distributed and/or not in their final possible formats, etc., are all supported by the teachings herein. As envisioned herein, participating users are provided with opportunities to inform and affect the creative and/or financial position and viability of projects, including those related to film, or other creative or non-creative endeavor, person or opportunity.

In an another example, an interest is taken in an innovator as a function of custom media provided to a user and that relates to that person and/or creation(s) associated with that person. By selecting an innovator to sponsor, a user may own or otherwise have an interest in a certain designated “piece” of that innovator, as defined by terms and operability set forth by the venue, such as an Internet site. Specially provided and/or updated messages that may be selectively customized to include computerized altered media based on user-specific information, including incorporating information or media representing the user, may be sent to or accessed by the user at various point(s) in the interactive experience after initial “sponsorship” funding has been provided. Moreover, interactive sessions with the innovator directly with or without other sponsoring users may also be provided to allow for prompted and/or unprompted, free form creative/opinion based feedback that relates to the innovator, the innovator's work related to the sponsorship, or related at least partially to cross marketing partners, brands, and/or advertisers who are related to the project (e.g., opportunity), venue and/or innovator.

Additionally, interactive data or video sessions may be provided to include operability to further lure or entice users to engage in an opportunity and provide feedback, opinions, information and/or financial funding. Participating users may be included in media provided to other users. For example, a participating or potentially participating user may be provided with an interactive session to participate in a project, and that involves the user being knowingly or unknowingly provided within video (e.g., visually and/or audibly) as part of the interactive media, either in a “live” format or a previously recorded format, and shown or provided to at least one other user. In one example, the degree of involvement is selected as a function of the participating or potentially participating user's respective sponsorship.

Herein, a unique combination of incentives provide the powerful option of funding and/or informing projects, while providing user experiences and incentives powerful enough that in selected configurations user(s) are satisfactory to the extent that no further compensation or reward is provided, even should respective project(s) not meet predetermined criteria or thresholds of providing subsequent (potentially additional) incentives or performance-based rewards.

In one configuration, users opting into projects gain exclusive media participation opportunities to provide information and/or engage interactively in sessions directly related to selected projects. Further, interactive sessions may themselves include further possible rewards provided to such users for providing additional interactive data, such as preference and reactionary information. Further, participation in a project may include the potential of being a greater aspect of the final project, for example, a user supporting a potential TV SHOW, might be a potential aspect of that TV SHOW, such as a function of one or more interactive options.

In one configuration, a talent show program, such as the well-known program, AMERICAN IDOL, is provided as an advertiser-based project and may be, for example, shown on a specific video channel, such as a YOUTUBE channel, or may be broadcast “over the air.” In this example, selected user(s) are featured on the talent show program. The user(s) may be featured in some way to a relatively small number of internet or other interactive users, and may be a specific subject relative to interactive data exchanges. Moreover or alternatively, the user(s) may be featured to millions of viewers through a related venue, such as on television. Thus, a user supporting the talent show program or a related interest, such as a project, person or advertiser related to the talent show program may be provided with various incentives, such as an increased likelihood to be featured as a “guest judge” and featured to millions of home, interactive and/or non-interactive viewers.

Thus, “custom media” incentives may be provided to include literal alterations to recorded media and that are based on user information. A participating user may be included as an aspect of media and provided in live or pre-recorded contexts to other users or linked media viewers, whether or not the viewers interactively participate.

Further, by simply joining a venue and/or by exchanging information typically required for joining a interactive Internet web site venue (e.g., demographic information, professional information, preference information), a user may acquire certain options related to identifying opportunities. These include locating and accessing promotional content, such as downloaded and/or streamed video clips. Opting into a project/opportunity financially or with an exchange of information valued by the venue, at least, may provide a user with additional operability, such as the ability to search for and locate opportunities and information, which may be based on criteria through premium options.

For example, a user who has not only joined a venue, but who has also opted into at least one project, is able to access premium search functionality based on other participating members' trait and preference information. This information may include personal facts, such as private information not limited to sexual, social and emotional preferences. Thus, a versatile and intuitive search engine is provided for users who might be “checking out” project participation opportunities, and who might locate ones they would not other wise have discovered, as a function of a layered interactive sessioning that may include searches for information.

This includes operability options for the system to influence those layers of interactive exchange, even steering a user toward information the venue, an advertiser, a project offering or other interested and/or paying party want to expose to and/or extract from a user.

Thus, users who are potential providers of feedback, opinions, information and/or financial funding for projects may further be exposed to projects that they may not have otherwise considered. For example, a user reviewing projects, other users, or other information might provide information about himself directly or indirectly, through his interactive transmissions and choices. This informs the system programming to identify that user for specific information. For example, the information may be an invitation to preview another project or opportunity related to the user's interests, and/or a combination of the user's interest, interests of providers or supporters (e.g., paying advertisers) of the venue. In this way, a home project participant may in fact be “steered” by venue priorities, however discreetly, to other opportunities and/or interactive options. These may include live video sessions, or shows, or channels, potentially occurring at least in part based on biased priorities, such as paying advertiser's objectives and/or featured project objectives; meaning those project(s) seeking funds and/or preference information from specific people or groups of people, such as defined demographically.

Further, discreet factoring of preferences and aspects of individuals, for example, based on psychographic system awareness/programming, may result in a user being prompted or taken directly to other interactive aspects, such as live video channels, or opportunities, such as people to sponsor, or advertiser based opportunities, such as special purchasing or bonusing options at least in part based on priorities benefiting the venue/site.

For example, a user sponsors an independent film to be produced after the user watched a video teaser about the film. The user develops an interest in an other project by being exposed to the other project by virtue of a profile or user-provided information, such as related to searching options that are tracked by the system, and that result in a new potential project being located by the user. In this example, a big budget feature film with COKE as a sponsored cross marketing partner seeks financing and is made available to the user as a link or other prompted information. This user is solicited to join a COKE-influenced discussion forum regarding the film and offering opportunities for users to provide feedback about a possible ending to the film and/or to become a financial partner in the film. Thus, the system determines the respective user's interests, benefits to the venue/site, benefits to a cross-marketing partner (e.g., COKE), and a project's financial relationship with the venue/site, and makes a determination to steer a user a particular project, even though steering the user to a different project might have resulted in a more lucrative result. Through the interactivity of the user and system programming herein, in this example, suggestion(s) are provided by the system and biased toward user experience criteria, such as the user's likelihood to not feel manipulated or otherwise not in control of the user's interactive session, as well as the one or more revenue generating criteria (i.e., what might be earned for a project and/or advertiser for delivering a user to their interactive session, or video, or other information related to respective objectives).

Accordingly and in an embodiment, a venue in accordance with the teachings herein strives to maintain the user's “illusion of control.” A high degree of relevance to a user is a system programming option that can powerfully enhance the user experience, the user's likelihood of continuing with the interactive session and the user's willingness to receive information and/or engage in a financial commitment, or special exchange of information, as respectively valued by the venue.

Further and in an embodiment, a social network is provided, wherein users seeking information on project opportunities may be steered to related people such as other users, to contact, view, or otherwise take interest in. As a result, a social network is provided to deliver unique operability by directing users from initial interest in a project or person (or people), to projects and/or other people whom that user would not have otherwise discovered and taken an interest in. The combination of features, such as user demonstrated preferences and venue-based interests, such as those of selected projects and/or advertisers and/or other entities with venue involvement, enables the system to steer users to projects and people not otherwise considered.

Further, users participating in an interactive venue provided in accordance with the teachings herein, configured with or without social networking operability, provide high quality focus group information for projects. Beyond funding and informing the viability of selected projects such as films of interest, users are prompted to take an interest in other, potentially related, opportunities. For example, a user who took interest in funding an independent film about fashion, is steered to an interactive chat room and/or interactive venue such as video channel.

For example, a user is steered to a video channel wherein CALVIN KLEIN is seeking information about the new season preferences from users who demonstrated certain traits and/or preferences. In an overtly solicitous scenario, a new CALVIN KLEIN fashion line is discussed by users, who may or may not be incentivized to participate with credits or other things of value. Thus, those users seeking to participate in interactions relative to projects, people and other users, might end up providing feedback about a designer's new line and be featured in a video channel to a plurality of other users relative to that topic, and perhaps relative to the fashion film a user took interest in, as well as the advertiser's influenced topic and focus group data soliciting forum.

Further, this exemplary “influenced” session might result in a user interacting with another user(s) as a result of a film project and/or CALVIN KLEIN influenced topic(s,) perhaps both users being within the chat room/video channel related to this to, which they were both at least in part solicited. And, such users may interact by being exposed to visuals and/or profile information about each other, or other system provided information, thereby drawing a user's attention to other users for social interaction. This multi-purpose interactive configuration of a venue provides powerful influence over project opportunities and venue-valued information users find and act on, while also broadening and improving the user experience with social interaction and/or information searching options at least in part related to the project opportunities in which users may collaborate and/or participate.

Again, such “drawing of attention” to other users may or not be affected by a bias toward various venue-related interests, thereby allowing for discreet if not otherwise invisible advertising opportunities. For example, a determination about other users of interest to a user in the CALVIN KLEIN/FASHION MOVIE related channel, might lead the system to suggest a female or group of users, with the system bias of directing the user now to a new interactive opportunity related to Ford and automobiles.

Thus, keyword or other system-analyzed user interactive information is used for options that are provided or imposed on a user during an interactive session. In this instance, resulting in the user establishing repeating dialogue with a female whose fashion and automobile interest related to the user. Further, the user ended up opting into a non-entertainment project related to travel, in this case involving FORD as an interested party. This in turn benefited the venue financially for delivering this initially fashion focused user to Ford's biased interest and interactive opportunity, perhaps as a result of other information about the user demonstrating that this user met FOCUS GROUP or other targeting criteria for FORD to solicit and pay for the user's interest.

Further, the venue may have filtered the potential automobile tangent through user experience/relevance programming, to determine if the option of delivering the user to Ford's information or opportunity would maintain or lose the user's interest or interactive participation, relative to other options, benefiting or the venue or not. This, all to maintain the illusion of control and highest degree of user experience and “editorial” integrity to savvy users, who know when they are being steered or manipulated in many cases.

Projects, which may be media projects that are already at least partially created, such as films that have been photographed yet and are not in a final edit stage, may be important project options for certain venues. The benefit here, is that projects that at least in part include media as an aspect, may have existing media aspects ready to be provided for funding, focus group data, creative options opinions, and other interactive possibilities that users may provide that are valued by at least the project maker(s).

The present system/method is, in one configuration, a computer managed network liked by wire and/or wirelessly between data managing and transmitting/receiving units. Further, components of the system/method, including the incentive custom media option, are also fully computer managed in this configuration.

To focus on three key data providers: 1) The venue/site hub computer(s); 2) the project media provider and the 3) home interactive user. A project provider uploads sample media to the hub computer. The home user opts to participate financially in the provider's project. The home user provides at least personal identification information in joining the venue/site. The project provider's project is or is not created, as an option of the hub computer based, for example, on a threshold of user participation dollars collected in a prescribed period of time. The project provider who has been approved by the hub computer to receive all or a portion of collected funds, subsequently provides at least project representative media to the hub computer, optionally including programming references comprehensible by the hub computer(s) to use in altering the representative media to create unique versions of final media for optionally each participating home user. Within prescribed terms, the hub computer then conveys final customized/altered representative media to the participating user. These are example stages of at least some automated functions/stages of the system/method, demonstrating the interactive flow of information between the three key data providers. Other information and interactivity may occur, or replace any of these stages, thought in this configuration, the soliciting, funding, customizing media and providing, are all demonstrated as stages of information exchange over the network providing data related to the site/venue.

One or more configurations of the present application may further relate to projects where specific events occur at specific times, be they live performances, production of scenes for a film or other media program/product, unveiling of a special creation, among other event related aspects of a project's creation and/or presentation to a venue user's participation in a project/offering. Among the incentive options, handled by the system computer automatically in a preferred configuration, are live participation by users based on a consummated level of project participation/support by such users. Using an independently produced motion picture project as the example of this live participation and incentive scenario, such a production may be “green lighted” as a result of at least in part enough users supporting the project financially.

In such projects, a “shooting schedule” may be exemplary of special information provided to supporting/participating users meeting certain venue criteria. Should a “scene” of a film be scheduled to shoot on a date in a specific city, for example, such users might be enabled to reserve options to appear live at that specific day of shooting, to witness at least part of the production in person. Their “user” or “home producer” number of other identification may be automatically provided to the production, with users who were accommodated by the scheduling programming being listed as possible live attendees of the event who should be provided the prescribed access, as an access of their participation incentive. Such system operability may further be applied to live creative events, or project expositions, unveilings, updates or project related aspects that may be presentable to selected users live.

Yet another important optional dynamic and aspect of the invention operability is that projects that meet selected “support” criteria from users that are produced to the agreeable stage of such “green lighting,” may remain open for users to support past that point, empowering that project further. For example, a film seeking financing that has yet to be photographed, might exceed the necessary “green light” funding amount by a prescribed date. After that point, at least the funding support by other users might remain open for an additional time period, allowing funds beyond the green lighting amount to further enable the project viability and value to at least the interactive users. Thus, a film with a $5 million green light threshold, might earn over $10 million by the time the film is photographed and provided to the “home producer,” or interactive user supporting that project; provided for example featuring that user's name featured as “customized media” within an initial, non-final “rough cut” version of the film.

The extra funds, within venue parameters, may enable selected distribution and/or promotion of the project, and/or additional premium production aspects that might occur after an initial production phase, for example. Thus, the tiered user support of a project might enable levels of production, post production and venue detailed project aspects. In this example, those might be a film being first shot and presented as “rough cut,” then edited as informed by “home producer” users into a final cut with possible informed revisions; then distributed to a prescribed number of theaters, etc. These options all being preset and options attainable based at least on interactive “home producers” financial and/or other support.

Thus, the powerful interactive potential to fund projects by providing interactive experiences and incentives to information and funding providers, or users, is herein enhanced. The range of projects, featured through media, is also expanded. And, the interactive involvement operability and interactivity between related users is enhanced.

In yet another configuration in which an Internet user interactively demonstrates support for a project, automatic and subsequent transmission(s) of a unique version of the project is generated therefore. In an embodiment, an incentive involves computer(s), such as in a configuration of a system hub, altering and/or adding one or more aspects within a media file, and subsequently transmitting a user-specific media incentive file, such as a digital audio and/or video file. The file may be formatted as a “QUICKTIME” or similar media file, one or more files provided in DVD compression format, or any other selected format agreeably exchanged with the user's computing system from the system hub computing functionality. User computing systems may be home computers, PDA devices, cable televisions addressable “boxes,” may be other media receiving and converting/displaying devices, or may be other known media compatible receiving and/or storing and/or displaying hardware.

Moreover, and continuing with this embodiment, the incentive media file may include customized versions that alter and/or add content, such as media, to a selected, general version media of one or more project. Such general version media may also be referred to or known as a “universal version,” which relates to a version of a project distributed to at least two other recipients in an electronic transmission of the project. The general version may be transmitted to selected recipient(s) and/or may otherwise be modified to create a customized version of the general version media, as an incentive to project funder(s), for example, that is particular for that funder.

In one example, name-related information is transmitted from the user to the system computing component(s) and, in response to a prompt, and the information provides an example basis of information capable of being relied on for creating a user specific custom media file and subsequent transmission. Such name information may be incorporated into the producer credits of a motion picture project, or other audio and/or visual project and/or media related to a non-media based project from which media has been captured and/or created.

Further, in addition to or in place of name-related information, media may be provided by the user, for example through internet connectivity. This user-supplied media may be incorporated into live action or other project media within the general or universal project version to create user specific, customized media file for transmission. Such user-provided content may be incorporated within, or at least informing, unique customizations of the general media file, relative to each such incentive media recipient, such as a project supporting user. Further, text information, such as the user's name and/or media, or other basis for modification or addition to the general project media, may be relied on in the creation of the incentive media file(s). Preferably, all such exchange(s) of media and/or information in the creating of such uniquely customized file transmissions containing such incentive media file(s) should occur automatically, at least in part as an aspect of system computing and user computing operability.

The incentivized funding of projects, such as motion pictures, is expanded with the introduction of the media containing and/or accessing device(s) herein. When connected, such data drives and/or multipurpose promotional devices transmit user related identifiers during, for example, at a point of purchase, from Internet site(s) that may all or in part represent the financial commitment of a user in sponsoring or at least participating in a project. Further, the purchase a storage device 100 may further not involve financial or other project participating. Device 100 can simply provide media access, such as via a subsequently linked computing device. Moreover, incentive(s) related to the media or a linked sponsor, including related to a distinct functional/use of device 100 (e.g., VISA credit cards with their magnetic strip) may be offered via device 100.

For example, a user acquires an eight gigabyte drive storing a haunted film and formatted as a small MAGLITE flashlight. The flashlight is featured in a motion picture by a product-placed sponsor, including in scenes where kids search though a haunted house using same brand name flashlights. The drive contains the film, “HAUNTED,” along with another full length featured and several new songs from various artists, as well as a HOME PRODUCERS series of teasers providing scenarios to become HOME PRODUCERS in response to the purchase of the device 100. Further, device 100 allows for additional USB and/or wireless access to finished films in both a HOME PRODUCERS library and in a database of films accessible by UNIVERSAL STUDIOS, the studio releasing HAUNTED. Accordingly, up to three additional copies of the film, HAUNTED, can be saved or “burned” to DVDs under respective licensing arrangements.

Continuing with this example, the hybrid MAGLITE device 100 is brought by the user to SAM'S CLUB, (a sponsor of the cooperative promotion as well and in this example also featured store in the plot of HAUNTED) for the user to gain automatic access to SAM'S CLUB, by virtue of data exchanged between device 100 and the store computing device. The purchase of goods at SAM'S CLUB may further automatically provide a data exchange and resulting credit or other incentive provided via device 100. Moreover, a $100 purchase or more at SAM'S CLUB activates a higher level of participation in funding a creative project associated with the user and storage device 100. Further still, SAM'S CLUB may physically and/or wirelessly register the device to allow for download or additional media access benefits for the user, and/or ability to create additional copies of the media within licensing terms, which would otherwise not be possible without meeting a basic requirement, (e.g., a minimum purchase at SAM'S CLUB).

Further, in a reverse scenario, activity by a user related to media partner(s) of the program associated with the device, such as HPC and/or UNIVERSAL STUDIOS in this example, may advantage the SAM'S CLUB aspect/coop of the system/method, in this case as affected by data exchanges involving the MAGLITE hybrid device 100.

Further, storage device 100 may be configured and/or formatted as a cell phone or other communication device. For example, a software application installed on an IPHONE provides cooperative interactivity between external databases related to a user, such as the IPHONE application operability accessing the application managing computer associated with managing the application outside of the phone itself. This computer then communicates or “links” with HPC, (e.g., over the Internet) to authenticate the user's identification data and then to provide/access the HPC benefits/options for a user (or potential participant/member).

Such a communications device may further provide user and cooperative benefit (cooperative referring, generally, to a group of two or more involved parties such as firms seeking user related revenue and or user data) by enabling incentives for purchase and/or use of the phone, in exchange for data. For example, a person buying an IPHONE might pay half price by agreeing to at least one interactive survey based on media provided (or other topic) to the IPHONE for user review. This media might be related to the previously disclosed HPC options, for example, and/or may simply relate to focus group sampling related to the user's preferences and/or reactions to supplied stimuli. Failure to meet the interactive agreement/obligations might selectively result in the discount for the item (such as IPHONE) being rescinded and billed, or similar disincentive to maintain the surveying/data-sampling priority of the venue and/or co-op providing the initial incentive/discount, or the like.

Alternatively, and in accordance with the teachings herein, media projects, such as potential movie projects, are distributed on customized storage devices that provide an ability for recipients to participate in the projects to receive incentives. One incentive may be, for example, featuring recipients who contribute financially to the project in various ways. For example, recipients who participate in or contribute to a project have their names shown in the closing credits of the movie, or the participants may be featured during the course of the movie. A plurality of project participants facilitate the funding or other production aspects of a project, and reduce or eliminate financial and other risk normally borne by producers.

In one embodiment, a system and method is provided for distributing media related to a project. A storage device is provided that stores one or more electronic media instructions for accessing the media. Moreover, an incentive is offered in this embodiment is information representing at least one incentive, and an electronic identifier representing the data storage device. Further, a first computing device is operatively coupled with the data storage device, and to a second computing device. The first computing device transmits the electronic incentive information to the second computing device and, in response, the first computing device receives from the second computing device an electronic authorization to provide the incentive.

Inserting custom-generated name credits within media projects, including motion pictures, to convey those who participate in the projects, such as by funding, is known. In one known system, people indicate a commitment to participate in projects via, for example, the Internet, cable television network or other electronic interactive communication network. Moreover, user-specific or participant-specific, customized media are delivered to individually addressable media managing modules, including, for example, individually addressable cable television receiver “boxes,” desktop computers and portable devices and cellular telephones, such as the IPHONE, or other portable devices, including the IPOD TOUCH and BLACKBERRY communication devices. In this embodiment, such devices run applications that allow a variety of user-specific customization options. In one example, information from or related to participants and/or users of a project funding system tailor live action and/or live actual media. Participants in the funding of media projects link electronically to a hub device to that coordinates, computes and transmit transmits tailored media to all such participants.

In accordance with the teachings herein, other kinds of media-related incentives are provided to participants of a media project in addition to or instead of customized written credits that are displayed in a project. For example, an actor in a film, e.g., Sharon Stone, speaks the name of a project participant during a motion picture in which she appears. In this example, Sharon Stone speaks the line of the dialog in the motion picture, “Craig Mowry is the one to blame.” In one embodiment, her dialogue is electronically generated at least in part as an aspect of a digital media file created and conveyed from the aforementioned hub to one or more computing devices of a participant, or system user, i.e., Craig Mowry, in the present example.

Accordingly and continuing with this example, the incentive provided to a participant is that Sharon Stone says the name of the participant who funded or otherwise participated in the project. The participant may provide useful information that may include, for example, marketing information, demographic information or the like that is provided to an incentive provider/facilitator, associated with the film or other related media/project. In an example embodiment, digital options for computer generation and/or live captured material are provided to transform visual and/or audio information, including to alter images and sounds based on an anticipated appearance and sounds created from the phonetics, for example, related to a recipient's name. Such images and/or sounds affecting names or other media content are typed or are alphabetical and/or user identifying character submissions in this embodiment. These submissions identify computing operability of the teachings herein, including by distinctly programmed transforms and/or media generating/modifying digital bases prepared and/or assembled for at least this purpose.

As used herein, the term, “incentive receiver” refers, generally, to a user of the systems and/or methods herein and who receives an incentive in exchange for contributing something of value to an entertainment project. For example, an incentive receiver may contribute financially or may contribute something else of value, such as information that is of particular interest to one or more parties.

Another example of modifying and/or generating unique media for inclusion within other media received by participants of a project is a scene in which an actor is shown closing the cover of a diary in a particular motion picture. For example, the cover of the diary shows the name, “Craig Mowry,” indicating that this is the diary of the media participant or incentive recipient and/or system user, “Craig Mowry.” Moreover, in preferred embodiments, a plurality of participants respectively receive incentives of a similar type. For example, if one million individual participants of a project are incentivized with the same tailored media aspect, as many as one million separate names may be created to be featured on the cover of this diary.

In an example embodiment, a variety of computing devices, including desktop computers, handheld devices, cable television computing and displaying units or the like, are supported in accordance with the teachings herein. Media elements of special interest to an incentive receiver or other user are made variable by digital transforming operability, such as by a data managing transform software application imposed to a digital file representing an initial media file, thereby providing a revised media file. In an example embodiment, each revised media file includes at least one modified digital sequence, which is unique to each distinct user involved. For example, a sequence is revised to include an incentive receiver name. As noted above, a plurality of incentive receivers' names are respectively shown for each of a plurality of incentive receivers in a plurality of customized, revised media files and provided for each of the respective receivers/users.

Moreover and in one embodiment, storylines or various features of a project are alterable, thereby allowing a user of the system (such as a funding participant in a film project) to be involved in the plot and/or other element of the project. For example, in the known film, THE USUAL SUSPECTS, the often mentioned character, “Kaiser Sosay,” is modified to a distinct name that is featured repeatedly in the plot and media, and that represents each separate media recipient. Participants in a media project supply name information, and each receives distinct versions of digital files of the motion picture, THE USUAL SUSPECTS, that feature their names according to their supplied name information, to be the heard and seen in place of “Kaiser Sosay” in the initial media file or standard version of the film, as released.

Accordingly, media tailored in accordance with an embodiment demonstrates an ability to receive and share and/or give media incentives that feature participants/recipients. This provides a powerful lure, such as in the form of uniquely provided, e.g., typed credits such as a producer credit leading in a film or other media project, or altered media element(s) within the story/content of media. Such incentives are likely to be sufficient for many in exchange for a financial contribution or other participation in the project. In this way, a plurality of participants facilitate the funding or other production aspects associated with a project and reduce or eliminate financial and other risk normally borne by producers. Beyond financing a project from multiple users receiving at least one potential incentive, this interactivity relating to end users/viewers makes a project possible, or facilitates the gathering of information related to the potential creation of a project. This interactivity also brings filmmakers and audiences more closely together, thereby creating options to fund, inform and/or affect creation of entertainment or other creative projects than ever before.

In addition to facilitating funding and other production aspects associated with a project, the teachings herein relate to a point-of-purchase sale of media, including entertainment product(s), such as feature films, music, television programming or the like. More broadly, a new form for entertainment project distribution and/or distribution in conjunction with unique incentives and marketing operability to consumers is provided.

In a preferred embodiment, a reusable computing storage device or other similar information storage device is employed in one way to distribute entertainment products in addition or in place of conventional optical discs, such as CDs, DVDs or BLU-RAY discs. In an example embodiment, relatively small consumer storage devices having a data capacity size of, for example, four gigabytes, eight gigabytes or larger, store one or more entertainment products in digital video, audio and other entertainment files including, but not limited to, files provided in prior art DVD compressed and played format media.

In example embodiments, a system and/or method are provided that include suitable digital storage devices, such as palm-sized four gigabyte (or other sized) portable digital storage units, that allow for further operability, thereby expanding entertainment distribution, reach and revenue.

In one embodiment, the media storage device stores one or more features that automatically provides computer-related options such as: PLAY MOVIE NOW, BURN DVD or CD from media, COPY MEDIA TO DESKTOP and/or other useful, easily presented media managing and viewing options.

Moreover, in an example embodiment, executable instructions and/or data (e.g., software) are bundled with the data storage unit, such as data that are stored on the device and/or linked to other database(s), such as through the Internet, including substantially automatically through a web connected and/or network connected computer to which the storage device is coupled. Such software allows for additional operability and media management, relative to media stored within, or related to, the data storage device. Accordingly, the storage device according to the teachings herein contains and/or provides access to media that is accessible via external operability, such as software or other data files, accessible to or stored in the device.

Thus, a single, small storage device is available for purchase, for example, at a store, where packaged goods, such as DVD, BLU-RAY or other media products are typically sold. In an example embodiment, the data storage device in accordance with the teachings herein is packaged in a unique and convenient way to feature the media it contains and/or to provide access to the media, both in packaging material and in the design of the storage device, itself. For example, a car film, SPEED RACER features a portable storage device in the shape and look of a coop partner's brand name race, and having the capacity to contain the film in a digital form, such as in the DVD compression format.

Referring now to the reference figures, in which like reference numerals refer to like elements, FIG. 1 shows an example hardware arrangement for viewing, reviewing and outputting content over a communication network, such as the Internet. As shown in FIG. 1, an information processor 2, optionally functioning as an internet web server, provides electronic content 3 to a user workstation 4 that communicates with information processor 2 via communication network 16. Content 3 includes, for example, text, graphics, pictorial, audio and video material. The user workstation 4 employs software that enables a communication session to be established between the user workstation 4 and information processor 2. Information processor 2 employs software enabling a communication session, for example an HTTP session, to be established between the user workstation 4 and the information processor 2. Also as shown in FIG. 1, a printer 7 is in an example embodiment controlled by user workstation 4 to provide printed output of content 3.

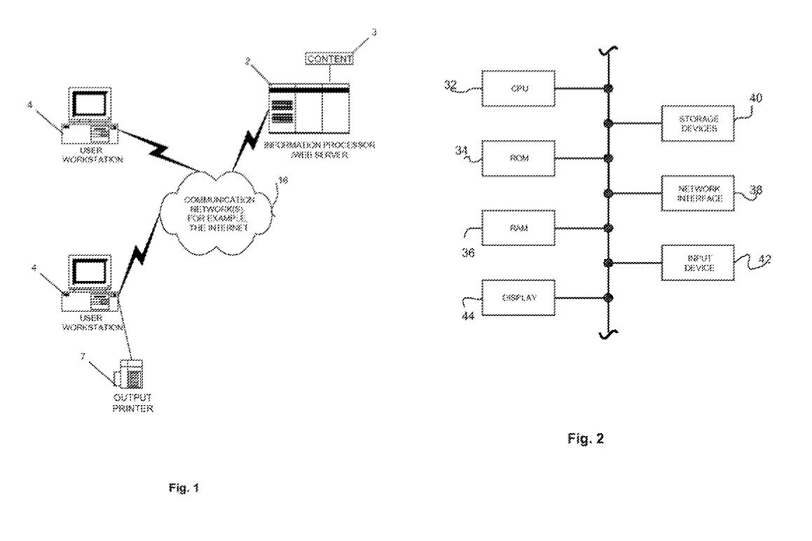

FIG. 2 illustrates the functional elements of information processor 2 and/or user workstation 4, and include one or more central processing units (CPU) 32 used to execute software code and control the operation of information processor 2 and/or user workstation 4, read-only memory (ROM) 34, random access memory (RAM) 36, one or more network interfaces 38 to transmit and receive data to and from other computing devices across a communication network, storage 40 such as a hard disk drive, floppy disk drive, tape drive, CD ROM or DVD for storing program code, databases and application data, one or more input devices 42 such as a keyboard, mouse, track ball, microphone and the like, and a display 44.

The various components of information processor 2 and/or user workstation 4 need not be physically contained within the same chassis or even located in a single location. For example, storage device 40 may be located at a site which is remote from the remaining elements of production user workstation 4, and may even be connected to CPU 32 across communication network 16 via network interface 38. In an example embodiment, information processor 2 includes a memory equipped with sufficient storage to provide the necessary databases, forums, and other community services as well as acting as a web server for communicating hypertext markup language (HTML), Java applets, Active-X control programs or the like to information processor 2. Information processor 2 is arranged with components, for example, those shown in FIG. 2, suitable for the expected operating environment of information processor 2. The CPU(s) 32, network interface(s) 38 and memory and storage 40 are selected to ensure that capacities are arranged to accommodate expected demand.

The nature of the present invention is such that one skilled in the art of writing computer executable code (i.e., software) can implement the described functions using one or more of a combination of popular computer programming languages and developing environments including, but not limited to C, C++, Visual Basic, JAVA, HTML, XML, ACTIVE SERVER PAGES, FLASH, JAVA server pages, servlets, and a plurality web site development applications.

It is contemplated herein that any suitable operating system can be used on information processor 2 and user workstation 4, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, WINDOWS VISTA, MAC OS, UNIX, LINUX, PALM OS POCKET PC, BLACKBERRY and any other suitable operating system.

As used herein, the term, “module,” refers, generally, to one or more discrete components that contribute to the effectiveness of the systems and methods described herein. Modules can include software elements, including but not limited to functions, algorithms, classes and the like. Modules also include hardware elements, substantially as described below. Modules can operate independently or, alternatively, depend upon one or more other modules in order to function.

As used herein, references to displaying data on information processor 2 and user workstation 4 regard the process of communicating data across communication network 16 and processing the data such that the data is viewed on a display 44, for example, by using a web browser and the like. As is known with web browsing software, the display 44 on user workstation 4 presents sites such that a user can proceed from site to site within the system by selecting a desired link.

Therefore, each user's experience is based on the order with which he/she progresses through the display screens. Graphical screen controls are available in the display screens and modules to initiate data processes, and to provide convenient navigation between the display screens and modules. In other words, because the system is not completely hierarchical in its arrangement of display screens, users can proceed from area to area without the need to “backtrack” through a series of display screens. For that reason, and unless explicitly stated otherwise, the following discussion is not intended to represent any sequential operation steps, but rather to illustrate the components.

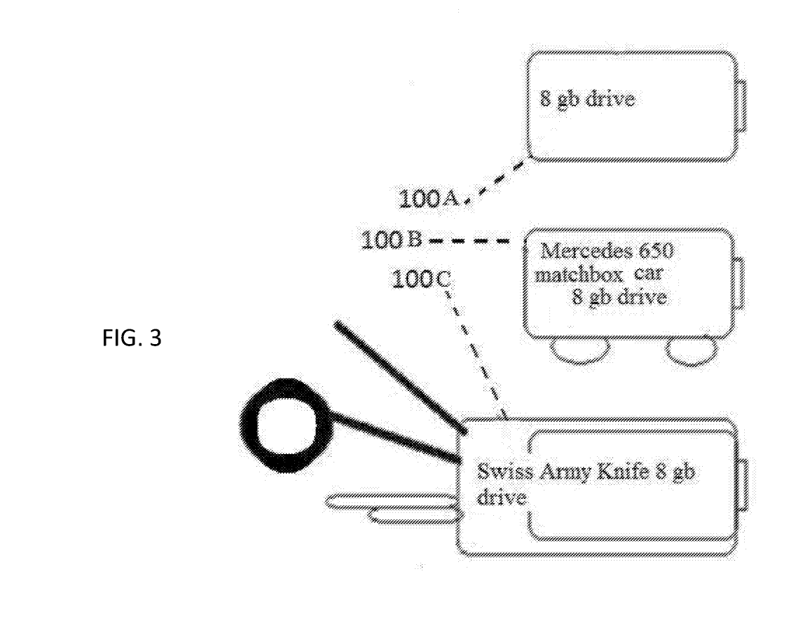

FIG. 3 illustrates three example storage devices 100 formatted in various ways in accordance with example embodiments. Storage device 102 is formatted as a typical USB flash memory device. Storage device 104 is formatted in the shape of a car or other vehicle. This type of storage type may be suitable for distribution of other films. For example, a race car for SPEED RACER, the BAT MOBILE for BATMAN, a jet fighter for TOP GUN, or the like.

Storage device 106 is formatted as a pocketknife, such as a SWISS ARMY pocketknife. Thus, and as illustrated in FIG. 3, storage device 100 can be formatted in many ways, in accordance with a particular context and/or for a particular purpose. For example, storage device 100 may be formatted as a boat, a microphone, a computer, a house, virtually any shape for a particular context. In one example, a JAMES BOND film storage device 100, has storage device 100 containment in the shape of an Aston Martin, while a storage device 100 in the shape of a weapon, such as a machine gun, when promoting a war movie.

Storage device 100 also has further distribution value and usefulness, including reusability. Songs, other media and various digital files are able to be stored on storage device 100, after using and/or copying of the media that was initially stored on storage device 100 to a computer, or other storage option/device, within operability and permission of storage device's 100 programming allowing for selective control of licensed use/copying of media, or the like.

Further operability includes revenue and business traffic motivating options, relative to Internet site(s) or other electronic venue(s) that function in tandem with media stored on storage device 100. Data and/or software stored on storage device(s) 100 allow access and privileges for further added value and/or additional media access. An example of this is an eight gigabyte palm sized USB storage device 100, and that contains one or two feature films as DVD format (or other) compressed files, wherein storage device 100 has been provided with operability (e.g., software) for storing additional media via interactive options selected by a user of the present system/method. For example, a user burns or otherwise copies onto DVD permissibly from selected media embodied within the storage device, instead of a limited number of copies, such as one for an archival backup or some other expressly permitted number.

In another embodiment, data storage device 100 includes automatic access to value or privileges within external venue(s), such as an interactive Internet site, which is accessible when storage device 100 is operatively coupled (e.g., plugged into) a computer with electronic access to the external venue(s). For example, data within storage device 100 automatically provides privileges and/or added value, such as membership having options provided via such a site or venue. For example, a movie club is accessible by a purchaser of storage device 100, and the movie club allows for streaming movies, downloading movies or other media, or other incentives/rewards. Access to the club is available to the storage device 100 purchaser by engaging and/or participating in interactive options provided by and/or via coupling storage device 100 with a computer accessing a site and/or venue. Further, accessing interactive options, such as via the Internet, enables a site/venue to confirm and/or authenticate the storage device 100 and/or holder thereof, such as by a code or other identification feature provided selectively automatically as a function of storage device 100. For example, data copied into and embodied within storage device 100 enables added value or additional options for a consumer to be authenticated. Storage device 100 and associated functionality is available at a point of purchase, or other purchasing options, such as through the mail, with purchase of a computer or the like.

In addition to storage device(s) 100 containing data files, other features herein in an example embodiment allow for a purchaser of media storage device 100 to be prompted to provide and/or to have information automatically provided to contribute to the personalization of media and/or other features of storage device 100 and/or media stored on storage device 100. Such functionality is typically not possible with DVD purchases or conventional movie downloads from Internet sites. In this embodiment, the participant's name or other identifying information in a prompted data field initiated by inserting storage device 100 into a port of a computer, such as a USB or other connection port, a resulting copied or “burned” DVDs is provided that has that person's name (e.g., Sally Smith) listed as a producer, such as “Sally Smith Presents” provided in the same typeface and/or in the same manner as other credits of the film or entertainment media. Such functionality is provided in applications programmed within storage device 100 or, alternatively, within external sources accessed in conjunction with storage device 100, and/or subsequent access initiated by use of storage device 100, or a related membership or arrangement made, at an earlier time. Further, Sally Smith is featured within selectively variable content with a film or other media, as in the above example in connection with the film, the USUAL SUSPECTS.

Thus, in this embodiment, a purchaser enjoys added value, including by having media within storage device 100 and/or media accessed from one or more external database(s) that is personalized for his/her own use and enjoyment. This adds interest and excitement to products that would otherwise feature the same information to all purchasers. The media stored and/or viewed as a result of purchasing storage device(s) 100 is revised to be unique to each purchaser, such as through the addition/change of a movie credit within the film, or with information/selections provided by the purchaser, such as in response to programmed prompts. For example, a film has modular components, including options for versions of scenes, and a user and/or purchaser of storage device 100 selects his/her own combination of options, thereby creating a personalized selected version of a film or other media piece.

A user accesses operability described herein to create version(s) of media that are unique to him/her. Such versions created and/or informed by user feedback subsequently is, at least in part, the basis of individual or multiple viewer preference information relayed to a venue database(s) for consideration in one or more modifications to version(s) of a project provided to those beyond the single, data-providing user. Version(s) may include, for example, a theatrical release version of a motion picture, or final aspects of a TV show, live event, other creative project or the like. The initial access and subsequent access to media, which is customized for a user need not involve a storage device 100, or any external unit at all, under various embodiments in accordance with the teachings herein.

Such linking operability allows storage device 100 to stimulate traffic and/or commerce of a venue and/or site, beyond simply providing an added value/bonus for the purchaser of storage device 100. Thus, a single purchase of a movie for example, provides the buyer with value and operability beyond purchasing a typical DVD.

In one example embodiment, storage device 100 is priced similarly to the cost of storage devices that are offered for sale blank and with no data preloaded thereon. Despite the media and/or operability, storage devices 100 featuring data related to the teachings herein are priced in connection with the method and objective(s) that has been placed thereon.

In one embodiment, storage devices 100 further includes added value options within its own operability, or in tandem via a coupled computer, Internet site and/or database. Storage device 100, in accordance with the teachings herein, is also reusable to store and distribute files between people, including music, movies and the like.

Moreover and in an example embodiment, storage devices 100 are designed to reflect marketing of project(s), including options for packaging and/or storage device 100 containment themselves featuring shapes, colors and visuals related to the media contained therein. For example, a WALT DISNEY film may be provided on storage device 100 that is formatted in a molded “MICKEY MOUSE” shape. Storage device 100 may also formatted in the shape of and be a fully operable credit card, with the media information occurring within the confines of the card or within a portion that extends beyond the conventional card, or magnetic stripe portion necessary for the conventional payment identifying operability of cards. Further, a card is alterable to be of the immediate identifying type, requiring no swipe but involving information transmitting and/or reflecting operability. This operability enables a credit card to take the form of whatever may be necessary and/or advantageous for the containment of, for example, the media information related to a compressed media piece, such as a normal resolution or high definition motion picture or television show. A credit card may include an eight or more gigabyte key chain accessory, or pocketknife device, or simply an eight or more gigabyte USB storage device 100, for example, which contains the credit card identification function familiar to credit and/or cards, such as those related to the MOBIL SPEEDPASS identification system.

Accordingly, storage devices 100 may be formatted as key chains, hung from pant loops, configured as jewelry, and/or may employ the versatility of becoming many objects of interest to people, beyond the devices' data-related functionality. From useful utensils to art objects and fashion, the unique shapes and designed results of storage devices 100 may allow for unique storage device 100 shapes/sizes capable of featuring feature films in high quality. These storage devices 100 may take on physical appearances (and even secondary usefulness and/or functionality) to provide added value beyond that expressly described herein. As used herein, these are referred generally, as hybrid storage devices 100.

For example, a hybrid storage device 100 functions as a credit card, for example, with a magnetic strip for at least identification data embodied on the card. A storage device 100 featuring a movie for example, may access operability within sponsors related to the storage device's provider (and/or media creator). For example, COKE sponsoring an INDIANA JONES feature film may allow a storage device 100 configuration containing a film's related media to be also inserted into a COKE dispensing machine for discounted, free or otherwise advantaged transactions, as a function of the data embodied in device 100.

Further, storage device 100 may have physical functionality, such as a styling utensil aspect of the storage device's containment. For example, storage device 100 includes or is formatted as a comb, toothpick, or knife, such as a SWISS ARMY pocketknife having many familiar retractable features. Storage device 100 may further include a USB connector or similar connectivity component in a fixed or retractable format, and having an internal and accessible data containment.

Further and in an alternative embodiment, data storage device 100 functions as a contest bonus piece in marketing projects. For example, a film featuring a brand of cars, such as JAMES BOND films and ASTON MARTIN cars, provides cross-marketing related storage devices 100 that embody media related to a JAMES BOND film and featured on storage devices 100, having operability to “start a car” when inserted into a USB or other communications port. Alternatively, a specially designed communications port receives storage device 100 that is provided at a particular location, such as a movie theater or retail establishment. Continuing with the above example, storage device 100 is designed as a CAR KEY, thereby creating a multi-functional, specially designed storage device 100. In another example, storage device 100 is formatted in the shape of a brand name product, such as a miniature ASTON MARTIN automobile, or the like. Objects of marketing interest not directly generating revenue may be created as well. For example, a movie filmed in France, or a live concert event in Paris, is provided as media stored on a USB and/or wireless storage device 100 or media accessing device, and formatted in the shape of the Eiffel Tower. Reciprocally, the car key itself, for example, may activate an actual vehicle, or other linked marketing device such as vending machine, or other incentive/bonus linked device, via the USB or other physical connector, such as those familiar to electronic car keys. Incentives may also be accessed/activated wirelessly by component(s) of the system, including wireless data exchanging operability.

Thus, one or more purchasers of storage device 100 receives added value incentive to see if his/her storage device 100 starts a certain car as a function of particular data stored in storage device 100, as in a marketing incentive program/sweepstakes. In this way, storage device 100 provides ancillary and/or tandem functionality that increases promotional and/or commercial value for projects involving selectively media, (such as movies), which are typically not available with optical disc and/or tape distribution, for example.

Accordingly and in an example embodiment, media such as movies are distributed on new types of media embodying devices, not limited to familiar palm sized storage devices, and that provide added value to such distribution of media options. These options need not be limited to media accessed in external databases. Added electronic and physical functionality of the media embodying devices may allow for added personalization options of media provided via the use of such devices, among other options of value to many users. Ancillary added value of the system may further include electronic contact with other individuals, perhaps automatically announcing a user's involvement in a program, for example, as an invitation to view media related to the project. Such an announcement may be customized media itself, e.g., a celebrity inviting others using the participating user's name through digital modification of at least audio and/or video information. This customized media example allows for the appearance of the user within the media, literally. Alternatively, information related to the user is directly related to the larger project, as least in the eyes of one or more people contacted as a function of the system (with the user's approval and/or user based information, such as a FACEBOOK friends list, or HOTMAIL email address book, or the like). In instances where a user is literally, visually or otherwise provided at least in part of the media within a customized media product, that user will have provided media or such media was accessed, representing the user visually and/or with audio.

Storage devices 100, such as USB portable storage devices 100, are more durable than typical DVDs, thereby providing advantageous shipping options, for example. A likelihood of damage during shipping is reduced, even in an unlined shipping envelope or box, as the USB connector (for example) may be retracted into the safety of hard plastic or metal. The versatility, small size, large media storage capacity and freedom from disc scratches/damage to media, are included among the advantages provided by re-recordable storage devices 100 over DVD media distribution options.

Beyond external system components containing or accessing information when connected to other components physically, further operability may allow for such external devices to function wirelessly at least in part as user identification devices. E-ZPASS units and other user ID devices for linking customers to external databases demonstrate the usefulness of electronic client identification. Such identification devices may or may not actually contain incentive media files, such as media related to a project in question (e.g., a motion picture). Instead, these devices may provide user identification operability for external components of the system to recognize an approved user of the system, and allow the user to access, obtain, download, stream or otherwise receive media and/or other pertinent information relevant to individuals identified and associated with such devices.

User identification devices that are operative components of the system and method herein include, for example, a user cell phone or other PDA device. These devices provide access to at least one database that contains information enabling the device to recognize a user. In another example, an E-ZPASS device is operable for user-identification. These external devices are not provided necessarily to users by operators of venues relating to the teachings herein, though through a cross marketing campaign. In any event, participants of a project access benefits and/or incentives related to their respective participation in the project. This is enabled by system identification of the participant involving electronic components related to external systems.

In one embodiment, participants contributing to all or part of a project, such as a music concert or a motion picture, are invited to attend a related screening and/or showing of the project or a live event. In one example, a drive in, or “E-ZPASS in” screening(s) is provided. E-ZPASS devices are read, as they are by tollbooth units, in the parking area where the event is to take place. Computing operability allows a venue under the present system and method to confirm a user's identification information with identification information provided from a database associated with E-ZPASS, permitting or unlocking at least one aspect of the incentive program, such as access to the live, screened, or otherwise presented event/project.

The cross marketing potential is enormous, as devices such as E-ZPASS exist specifically for the purpose of electronic client identification. Other potential value in accordance with the teachings herein is created when such devices are hybrid, or dual purpose products. For example, a fashion accessory, cell phone, or even battery operated key to a car includes user identification operability, such as the ability to emit or reflect transmitted signals to embody identification information. A device as simple as a credit card, or even a can of soda, may be embedded with information that wireless technology allows to be read for the purpose of identification, at least in part for the purpose of providing an incentive, such as access to media.

Moreover and in an example embodiment, an enhanced range of user incentives and advertising cross marketing options are created by linking databases, including databases that are maintained by third parties. For example, one incentive related to a participant providing information, financing and/or promotion related to a project relates to a component of the project, such as the music. A sponsor of the project, or interested party, might be COCA-COLA. An external identification device provides the information necessary for a COCA-COLA dispensing machine, for example, to provide a free product to an identified user or participant.

Further, a user may have provided other identifying information as an aspect of the promotion, such as his voice singing a selected song or sequence related to a project, or reading dialogue that occurs within the project. Such user-related database information allows for the user/participant to repeat his performance and sing the line or read the words in the proximity of a related system component, such as a COCA-COLA dispensing machine. Also, a password may be set, as part of all of the spoken recognition from the user by system components. In an example embodiment and through operability of databases exchanging information related to a user, in this instance incorporating an audio sample into the adaptation process, the recognition of the user's performance from audio comparative information allows for a free soda to be dispensed as an incentive for project participation. In this way incentives may be provided to those participating in aspects of a project, even those who simply spend time interacting on a website or otherwise provide information in association with the project. Thus, those participating in aspects of a project may at least be able to be identified for cross-marketing incentives or other rewards associated with their participation, or in exchange for their participation.

The potential of database information to identify a user may even allow for user recognition to occur visually, based on physical attributes of a user. For example, a camera component of a COCA-COLA dispenser machine captures an image of a potential participant for comparison with information on file within another system component, external to the dispenser machine. As with audio recognition, visual recognition program(s) may be employed in this identification approach. In an example embodiment, computing operability of the machine conveys the visual information in some form for single or multiple database comparison to identify a user/participant. On acknowledged identification of such a user, bells lights and a free soda are provided to excite the user's attention and to provide a simple but compelling reward in exchange for potentially something as simple as having answered a few questions using, for example, web browser software.

Moreover, beyond funding and empowering of projects, value may be created relative to at least advertising, promotion, focus group sampling, as well as brand promotion, facilitating a wide range of interests, related to information gathering, brand marketing, point of purchase and/or internet sales.

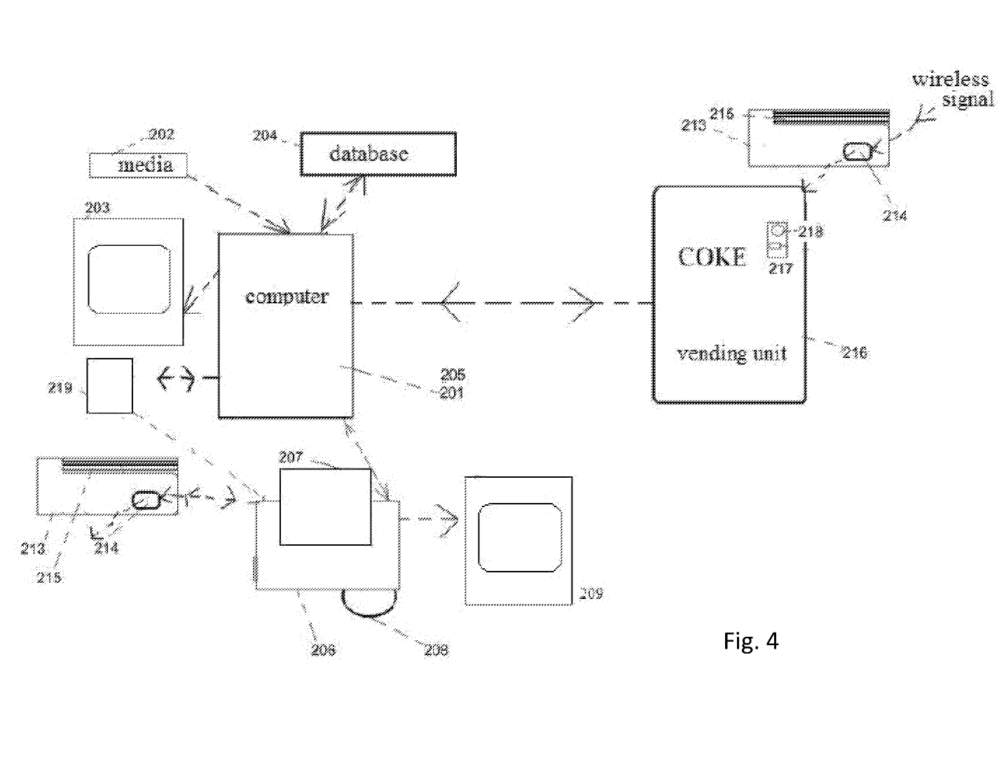

FIG. 4 illustrates functionality provided and/or improved by the present system and method. These example(s) demonstrate a broad application potential of each demonstrated system component and method aspect. Example brand names and devices are strictly exemplary of at least all equivalent brands and similar device options, within different and/or comparable configurations.

The hub of the database and computing operability of the site/venue provider, 201, is the HOME PRODUCER'S CLUB. Illustrating the cross marketing potential of a venue, this example configuration of the system and method provides brand benefiting value to at least the member/user, the HOME PRODUCERS CLUB, VISA credit cards, COCA-COLA company, PARAMOUNT entertainment and producers of their film WHEELS, SWISS ARMY knives, SONY music, REGAL CINEMAS, MATCHBOX toy cars, and IPHONE.

For example, PARAMOUNT PICTURES is desirous of involving HOME PRODUCER'S CLUB in funding and obtaining market research information related to their new motion picture, WHEELS. In the past, PARAMOUNT has used HOME PRODUCER'S CLUB to finance television, film and live event projects, including films that had not yet been produced until HOME PRODUCERS CLUB obtained an agreed threshold of user financing. In those instances, the users of the venue financing those films that achieved such thresholds, received early ROUGH CUT versions of the film exclusively for their reaction to specific aspects of the project, toward finishing and releasing the most potentially successful film based on at least this focus group information obtained from at least the HOME PRODUCERS CLUB members.

PARAMOUNT PICTURES provides initial media 202, related to WHEELS to HOME PRODUCERS CLUB 201. This media becomes an aspect of at least one database 221 associated with HOME PRODUCERS CLUB; this media is managed by at least one computing device associated with HOME PRODUCERS CLUB 222.

MARY WEST 220 is a member of HOME PRODUCERS CLUB, (“HPC”) having become a member by reviewing a series of entertainment project trailers a year ago and selecting an independent film (“JACKIE'S BIG DAY”) to finance in part, as a home producer. The $49.95 price to MARY seemed not far from the price of a DVD purchase, and through the venue, she was entitled to receive special incentives including potential credit for other services should the eventual film get made and earn profit through any number of other distribution possibilities, including theatrical release.

Further, in this example configuration involving HPC, Mary is entitled to early viewing and feedback privileges through the HPC, as well. Should the film be released in theaters, she is entitled to access to the final film in theatres for free, under the HPC and filmmakers' coop arrangement with REGAL CINEMAS. In order to access this free big-screen incentive, MARY uses one of a number of identification options. Her HPC VISA CARD, when swiped, confirms her HPC privilege with REGAL CINEMA database 204 through HPC hub 201 database 221, and computing operability 222. Mary's VISA CARD includes magnetic strip information extracting an ability as well as information transmitted directly and/or by reflected signals, such as by E-ZPASS and MOBIL SPEEDPASS user member/customer assigned devices or the like. As a result of Mary's investment in JACKIE'S BIG DAY via HPC, she not only attended an eventual theatrical screening of the final film, but she also provided feedback of an early rough cut related to the ending option she preferred. This among several other creative feedback prompts the filmmakers and derived feedback from HPC members affecting their choices in final film completion.

Mary also received a CUSTOM VERSION of JACKIE'S BIG DAY, wherein she not only appeared with her name among the producers' credits, but actor JAMES FRANCO actually appears to say MARY WEST'S name in two places within the film, relative to a plot point about a missing person, that she viewed on her computer display 209. This was accomplished by computing operability 222 of HPC implementing name information from MARY as provided by her computer 206 and stored in HPC database(s) 221. She was very happy with the benefits received for her investment of $49.95, and was provided with a CD burned of the unique version the HPC created for her, featuring her own name 208. She also received a $155 credit for other media and/or redeemable goods and services, made available by HPC, as a result of the film she supported becoming profitable, allowing for “success sharing” at least with credits related to the degree of financial success her film achieved within agreed parameters. HPC also provides the program where participants like Mary can receive profit sharing in their film, thereby providing the potential for earning money.

Mary also recently saw in a store that HPC was distributing TV shows, live event video, music and films in a new way: on USB, firewire and other computer connectable storage devices 102. She was intrigued to see that they were available not only as standard storage devices, but also as fun and useful dual-purpose (hybrid) objects and she purchased the SWISS ARMY knife/storage device option (106), containing the new motion picture WHEELS (from Paramount,) (104) for her boyfriend. The lead character in WHEELS carried this same knife, which Mary thought was clever cross marketing. She also bought WHEELS in another promotional format for her nephew, featuring the film on an 8 gigabyte storage device configured as a MERCEDES 650 car, the car that the star in the film used during the best chase scenes, allowing for yet another cooperative opportunity with toy maker MATCHBOX.

These in-store storage devices 100, contain WHEELS and additional media, including bonus music and a TV show. Further, Mary opted to pay a little more so her boyfriend could also automatically become a member of HPC by connecting his storage device 100 to his internet connected computing device, allowing him to access more media, including movies, and to burn up to 3 DVDs of WHEELS from his storage device 100. Further he is entitled to watch and/or burn a version of WHEELS featuring his name in the credits and in the film itself, other actors literally saying his name in certain scenes, referring to him as a much sought criminal. This is accomplished when his computer accesses the media transforming program(s) 222, of HPC through the Internet. The new storage devices 100 coming out now have the transforming software loaded within storage device 100, so now they need not access the HPC computer to customize media with the user's name. The software is downloaded at the user's option directly from storage device 100.

Continuing with this example, Mary's boyfriend can watch and/or burn a version of WHEELS featuring his name in the credits and in the film itself, other actors literally say his name in certain scenes, and refer to him as a much sought criminal. This is accomplished when his computer accesses the media transforming program(s) 222 of HPC through the Internet. Thereafter, storage devices 100 are distributed that have the transforming software loaded within storage device 100, so now they need not access the HPC computer to customize media with the user's name. The software is downloaded at the user's option directly from storage device 100. Mary's nephew was able to receive a modified version of WHEELS with a custom introduction, wherein a star of the film, CHRISTIAN BALE thanks her nephew by name. BALE's words and visual elements being modified convincingly as an added value functionality of the HPC system. Mary's nephew was able to send this introduction to twelve friends, and the introduction with his name in the producer credits as well, to six friends, both with proper licensing permission under the purchasing arrangement Mary made in buying the device.

Continuing with this example, Mary returns home and has received a new HPC VISA card 213. This card is also a media storage device 100, and is able to function both as a magnetic swipe credit card 215, and media storage device 100 that holds up to five feature films, among other media options. The card is a wireless information containment and interactive communication device, via interactive transmission and/or receiving component 214. Mary realizes as a HPC member, she may wirelessly or by physical connection to her computing device(s), receive the next film from HPC she agrees to receive. Beyond her financing and providing information to HPC projects, she now has joined the HPC library, able to receive and share certain entertainment projects, including films other HPC members made possible, for example, among other HPC licensed products. She is fascinated how her credit card/storage device links wirelessly to her laptop, and receives the media from HPC 201 initially in their database 221. She also enjoys the membership option of such media being received by her designated PDA or phone, in her case an IPHONE 219. In doing so, she has also made her phone and identification device for operability of HPC, thereby allowing her wireless identification access to event admissions, product discounts and even incentive product bonuses, such as a free soft drink from machine 216 that identifies her cell phone signal and confirms her identity via HPC 201 computer 222, which is linked to a soft drink advertiser's, distributor's and/or manufacturer's computer(s), 205.

Continuing with reference to FIG. 4, during Mary's next visit to the movie theater, she remembers the audio feedback she provided to HPC 201 through her IPHONE 219 in an audio feedback session, providing her with additional HPC credit for more media downloads and incentive privileges. The COCA-COLA machine beckons her through signage, to repeat her name, or a previously designated password, or repeat a phrase it displays for her. On capturing her voice sample at the vending unit 216 through microphone 217, the information is conveyed through coop partner COCACOLA'S computing operability 205 to HPG 201 computing operability 222, for comparing to the IPHONE 219 provided voice sample data held within HPC database(s) 221. On confirming her voice and membership, and entitlement to the incentive, a free COKE is dispensed with accompanying fanfare of lights and jackpot-like sounds, by vending unit 216. On her next visit, Mary is amazed to discover that the unit can now identify her visually, by comparing facial features, captured by vending unit camera 218, to image data she had provided to HPC from her IPHONE camera 219, as responsive video information she chose to transmit (featuring her face.) She also realizes that her HPC membership has now allowed for a free screening at the theatre, a ticket dispensing machine able to recognize and provide the free ticket by her voice or her VISA card, through linked-database recognition of her incentive.

Mary is now aware that the HPC system can identify her now by voice, facial recognition, her information emitting VISA card which is now also a media storage device 100, and her IPHONE, who's phone number is recognized by the HPC computer(s) 222. She has helped to get at least a film produced and has provided membership and benefits related to another film, WHEELS, to her boyfriend and nephew. She has received her unique version of media she has sponsored and shown interest in, through her computer 206 as displayed on her monitor 209. She now can download and share such projects on her wireless storage device 100, which optionally happens to be a VISA credit card, 213. That same card provides access to theatres for certain free or discounted viewing benefits for Mary, by virtue of her HPC membership and/or interactive history.

As a result of the venue and system/method, example brands benefitted include HPC, PARAMOUNT, VISA, COKE, SWISS ARMY, APPLE and the store selling HPC storage devices 102, 104, 106. Jackie was eventually even selected to go to a FILM FESTIVAL as a separate incentive option for HPC members chosen from many, whose film(s) they supported prior to production eventually got produced and screened beyond just versions related to user/member computers, like Mary's, 206.

In still further applications and/or configurations, creative projects, including those involving media creation, are at least partially funded through in accordance with the teachings herein.

Although the present invention has been described in relation to particular embodiments thereof, many other variations and modifications and other uses will become apparent to those skilled in the art. It is preferred, therefore, that the present invention not be limited by the specific disclosure herein.

1. (canceled)

2. The method of claim 39, wherein the first project relates to a motion picture.

3. (canceled)

4. The method of claim 39, further comprising generating by the at least one or more processors, a request to select at least one incentive that includes at least one interactive option related to at least some media featuring a celebrity.

5. The method of claim 4, further comprising receiving, via the one or more communication devices and from at least one other computing device associated with another user, electronic information that affects a selection of the at least one incentive.

6. The method of claim 5, further comprising providing, via the one or more communication devices, an electronic interactive communication venue for providing the request.

7. The method of claim 6, wherein the venue is a live, multi-media user interactive forum.

8. The method of claim 39, further comprising selecting, by the one or more processors, at least some electronic user information associated with the first user, to generate the initial electronic project media.

9. The method of claim 39, further comprising:
selecting, by the one or more processors, at least some electronic user information respectively associated with at least one of a plurality of registered users;
generating, by the one or more processors, electronic user distribution information associated with the selected at least some electronic user information; and
transmitting, to the user computing device, the electronic user distribution information.

10. The method of claim 9, wherein the selected at least some electronic user information includes contact information for the at least one of the plurality of registered users.

11. The method of claim 10, further comprising:
receiving, via the one or more communication devices, first electronic communication information from a respective user computing device associated with the at least one of the plurality of registered users; and
transmitting, via the one or more communication devices to at least the first user computing device, electronic user communication information that is associated with the first electronic communication information.

12-14. (canceled)

15. The method of claim 39, further comprising:
generating electronic scheduling information, by the one or more processors, for a schedule of at least one event associated with the first entertainment project; and
transmitting, via the one or more communication devices, the electronic scheduling information to the first user computing device.

16. The method of claim 15, wherein the at least one event is related to a filming schedule.

17-18. (canceled)

19. The method of claim 39, wherein the first entertainment project is one or more of an entertainment program, a not-for-profit project and a business venture.

20. The method of claim 39, further comprising determining, by the one or more processors, at least some other electronic media associated with the first electronic video media to the at least one of the user computing device.

21. The method of claim 39, further comprising providing, by the one or more processors, an incentive that includes at least one selected from a group consisting of: money, a financial credit, redeemable points, additional functionality, film credits, interaction with at least one other registered user, access to restricted areas, and featured participation in the at least one project that is represented in at least one second electronic media and transmitted to at least one other user computing device.

22. (canceled)

23. The method of claim 39, further comprising transmitting the distinct version of the first entertainment project to at least one third computing device associated with at least one other of a plurality of users.

24. The method of claim 23, wherein the transmitting the distinct version of the first entertainment project to at least one third computing device represents fulfilling an aspect of an incentive.

25-30. (canceled)

31. The method of claim 39, wherein the distinct version of the first entertainment project is uniquely based at least on a transmission received from the user computing device.

32. The method of claim 39, further comprising:
determining, by the one or more processor and based at least on at least the electronic responsive information, at least one other person who is relevant to the user; and
transmitting, by the one or more processors, the distinct version of the first entertainment project to a computing device associated with at least one other person.

33. (canceled)

34. (canceled)

35. The method of claim 39, further comprising generating, by the one or more processors, a request for at least one of creative feedback, textual content, and social networking contact information.

36. (canceled)

37. (canceled)

38. A system for generating and distributing distinct versions of an entertainment project to respective computer addressable devices over an interactive video distributing network, comprising:
one or more processors operatively connected to one or more communication devices and to non-transitory processor readable media, the non-transitory processor readable media having instructions that, when executed by the one or more processors, cause the one or more processors to:
receive, via the one or more communication devices from a computing device associated with a project provider, i) electronic video media respectively related to a first project and ii) at least one associated question to be presented to at least one viewer of at least some of the video media as a preference sampling prompt;
generate initial electronic project media by processing the electronic video media, the at least one associated question and a request for a predetermined financial contribution related to the project provider;
provide, via the one or more communication devices, the initial electronic project media to a first computing device associated with a first member;
receive, via the one or more communication devices from the first user computing device, electronic responsive information representing at least i) a payment from the first member that is directly associated with the first project, ii) a response to the at least one associated question, and iii) at least some information distinctly representing the first member;
generate a distinct version of the first entertainment project with at least one creative aspect at least partly as a function of information included in the electronic responsive information representing the response to the at least one associated question;
transmit, via the one or more communication devices to the first user computing device, the distinct version of the first entertainment project that includes the selected version of the first project; and
determine a value associated with the electronic responsive information and provide a credit that corresponds to the determined value to an account of the first member, wherein the credit is usable to at least to pay for ordered viewing of at least one other entertainment project.

39. A method for generating and distributing distinct versions of an entertainment project to respective computer addressable devices over an interactive video distributing network, comprising:
receiving, via one or more communication devices operatively connected to one or more processors, from a computing device associated with a project provider,
i) electronic video media respectively related to a first project, and
ii) at least one associated question to be presented to at least one viewer of at least some of the video media as a preference sampling prompt;
generating, by the one or more processors, initial electronic project media by processing the electronic video media, the at least one associated question and a request for a predetermined financial contribution related to the project provider;
providing, by the one or more processors via the one or more communication devices, the initial electronic project media to a first computing device associated with a first member;
receiving, by the one or more processors via the one or more communication devices from the first user computing device, electronic responsive information representing at least i) a payment from the first member that is directly associated with the first project, ii) a response to the at least one associated question, and iii) at least some information distinctly representing the first member;
generating, by the one or more processors, a distinct version of the first entertainment project with at least one creative aspect at least partly as a function of information included in the electronic responsive information representing the response to the at least one associated question;
transmitting, by the one or more processors via the one or more communication devices to the first user computing device, the distinct version of the first entertainment project that includes the selected version of the first project; and
determining by the one or more processors a value associated with the electronic responsive information and providing a credit that corresponds to the determined value to an account of the first member, wherein the credit is usable to at least to pay for ordered viewing of at least one other entertainment project.
